(19) United States
(12) Patent Application Publication
(10) Pub. No.: US 2017/0095883 A1
(43) Pub. Date: Apr. 6, 2017

(54) BONDED METAL PRODUCT

(71) Applicant: HONDA MOTOR CO., LTD., Tokyo (JP)

(72) Inventors: Ryotaro Takada, Hagagun, Tochigi (JP); Takahisa Tashiro, Hagagun, Tochigi (JP); Takeshi Yamazaki, Hagagun, Tochigi (JP)

(21) Appl. No.: 15/127,952

(22) PCT Filed: Mar. 25, 2014
(86) PCT No.: PCT/JP2014/058163

§ 371 Date: Sep. 21, 2016

(51) Int. Cl. B23K 20/10; B23K 35/02; B23K 20/02; B23K 35/30

(52) U.S. Cl. CPC B23K 20/10; B23K 35/3006; B23K 35/025; B23K 20/02

(57) ABSTRACT

A bonded metal product constituted by bonding a first metal workpiece and a second metal workpiece. Metal microparticles formed from metal having a value for oxidation-reduction potential positively larger than H₂ are scattered in the crystal grain boundaries of either or both of the first metal workpiece and the second metal workpiece. In addition, metal bonding is formed between metal originating in the first metal workpiece and metal originating in the second metal workpiece in the bonding interface for the first metal workpiece and the second metal workpiece. Furthermore, the mental microparticles and oxygen are not present in the bonding interface.

### TECHNICAL FIELD

The present invention relates to a bonded metal article (product) obtained by bonding a first metal workpiece and a second metal workpiece.

### BACKGROUND ART

A solid-phase diffusion bonding method described in Japanese Patent No. 4255652 is one of methods for bonding metal workpieces together. This method will be briefly described below. Two metal workpieces to be bonded are prepared, and fine particles of a metal such as gold, silver, or platinum are deposited in an island pattern on a bonding surface of at least one of the metal workpieces to be bonded. Then, the bonding surfaces of the metal workpieces are brought into contact with each other and subjected to a pressure and heat treatment. The amount of the fine metal particles is reduced to a trace or minute amount, and relatively low pressure and temperature are used in the bonding treatment, whereby generation of an intermetallic compound is prevented in the bonding interfaces.

As described in Japanese Patent No. 4255652, in the pressure and heat treatment of this bonding method, a metal atom in the metal workpiece is replaced by a metal atom in the fine metal particles, or alternatively the metal atom in the fine metal particles is arranged between the metal atoms in the metal workpiece, to start the bonding.

In this bonding method, the noble metal such as gold, silver, or platinum is vaporized by laser ablation, high-frequency heating melting, resistance heating melting, arc melting, or the like to prepare the fine metal particles. Thus, a so-called in-gas evaporation process is carried out. Therefore, in the bonding method, an apparatus for the in-gas evaporation process is required, so that large equipment is required and the facility cost is increased.

In addition, in the bonding method, also a vacuum apparatus for depositing the fine metal particles on the bonding surface, such as a chamber or pump, is required. This also leads to the large equipment and the facility cost increase.

In view of the above problem, a method described in International Publication No. WO 2009/131193, which utilizes silver nanoparticles for bonding metal workpieces, is known as a low-cost and simple-operation bonding method. In this bonding method, first, silver nanoparticles having a particle diameter of 1 to 40 nm and a reaction accelerator are mixed with a binder and a solvent to prepare a bonding paste. The reaction accelerator is added to accelerate a reaction (adhesion or bonding) between the silver nanoparticles, and contains silver carbonate or silver oxide with a carboxylic acid including a crystalline body thereof.

Next, the bonding paste is applied to a bonding surface of a metal workpiece, and two metal workpieces are stacked in such a manner that the bonding surfaces are in contact with each other with the bonding paste disposed therebetween. Then, the metal workpieces are heated to a temperature of, e.g., 250° C. or higher while applying a load in such a direction that the bonding surfaces are brought closer to each other. The bonding temperature is maintained over 10 minutes or more while applying the load to the metal workpieces. As a result, the binder is decomposed, the silver nanoparticles are attached to each other, and the metal workpieces are fired, so that the bonding surfaces are bonded together.

### SUMMARY OF INVENTION

In the bonding method described in International Publication No. WO 2009/131193, the silver carbonate or silver oxide is reduced to form relatively large silver particles. Thus, in this method, the silver nanoparticles and the relatively large silver particles are both present at the bonding interface. When such particles with significantly different diameters are present, it is difficult to achieve a high bonding strength.

A general object of the present invention is to provide a bonded metal article containing a first metal workpiece and a second metal workpiece bonded to each other.

A principal object of the present invention is to provide a bonded metal article having an excellent bonding strength.

Another object of the present invention is to provide a bonded metal article that can be produced with low cost.

According to an aspect of the present invention, there is provided a bonded metal article comprising a first metal workpiece and a second metal workpiece bonded together, wherein

fine metal particles, each of which contains a metal having a more positive redox potential than that of H₂, are dispersed in crystal grain boundaries in at least one of the first metal workpiece and the second metal workpiece,

a metallic bond is formed between a metal in the first metal workpiece and a metal in the second metal workpiece at a bonding interface between the first metal workpiece and the second metal workpiece, and

the fine metal particles and oxygen are not present in the bonding interface.

Thus, in the present invention, no oxygen is present in the bonding interface. In other words, passive films are removed from the bonding surfaces of the metal workpieces, the active underlying metal materials are exposed, and the strong metallic bond is formed between the underlying metal materials. The oxygen can act to cause brittle fracture. Thus, the presence of the metallic bond and the absence of the oxygen lead to an excellent bonding strength.

Consequently, in the bonded metal article of the present invention, the first and second metal workpieces are hardly separated from each other. Furthermore, the bonded metal article can be produced with low cost by simple procedures of applying the fine metal particles and then bonding the first and second metal workpieces.

In addition, since the fine metal particles are dispersed in at least one of the first and second metal workpieces, the strength of the first or second metal workpiece is improved due to the fine metal particles. Thus, not only the bonding interface but also the base material per se exhibits an excellent strength.

Incidentally, the fine metal particles may be applied in the form of a metal paste containing the fine metal particles, for example.

In general, the bonding interface has a higher hardness, while each of the metal workpieces has a lower hardness. When a high-hardness layer and a low-hardness layer are arranged closer to each other, a residual stress (internal stress) is often generated. Therefore, the bonded metal article preferably has a gradient composition that an amount of the fine metal particles is typically larger in a crystal grain boundary closer to the bonding interface and is reduced as a distance from the bonding interface increases. The hardness of the bonded metal article is gradually changed in a portion having such a gradient composition. Consequently, the internal stress is relaxed due to the gradient composition.

It is preferred that the metal contained in the fine metal particles has an oxygen adsorbability. In this case, the fine metal particles applied to the bonding surface are diffused while capturing the oxygen, so that the oxygen can be easily removed from the bonding interface.

The metal in the first metal workpiece and the metal in the second metal workpiece may have different melting points. In this case, the fine metal particles are dispersed in the crystal grain boundaries in the workpiece having a lower melting point in the first metal workpiece or the second metal workpiece. Furthermore, an intermetallic compound is generated from the metal in the first metal workpiece and the metal in the second metal workpiece due to the metallic bond at the bonding interface between the first metal workpiece and the metal in the second metal workpiece.

In this case, the strength of the low-melting metal workpiece is increased by the diffused fine metal particles. Furthermore, a satisfactory bonding strength can be achieved by the intermetallic compound.

As is clear from the above description, the metals in the first and second metal workpieces may be similar metals or different metals. For example, chromium-molybdenum steels of SCM according to Japanese Industrial Standards (JIS) are similar metals. Thus, for example, SCM430 and SCM440 are similar metals.

Meanwhile, in a case where a metal element having the highest composition ratio in the first metal workpiece is different from a metal element having the highest composition ratio in the second metal workpiece, the metals in the first and second metal workpieces are considered as the different metals. For example, in a case where the first metal workpiece contains Fe as the metal element having the highest composition ratio and the second metal workpiece contains Al as the metal element having the highest composition ratio, the metals in the first and second metal workpieces are different metals.

The first and second metal workpieces exhibit a satisfactory bonding strength when the thickness of the bonding interface is in an appropriate range. It is preferred that the bonding interface has a thickness of 0.1 to 1.8 μm. In this case, in a fracture test of the bonded metal article, fracture is caused not in the bonding interface but in the metal workpiece per se. The thickness of the bonding interface is more preferably 0.3 to 1.6 μm, further preferably 0.5 to 1.3 μm.

Preferred examples of materials for the fine metal particles include silver. Silver exhibits an excellent oxygen adsorbability. Furthermore, silver is advantageous in that a relatively inexpensive silver paste is easily available and exhibits a low environment load.

### BRIEF DESCRIPTION OF DRAWINGS

FIG. 1 is a longitudinal cross-sectional side view of a bonded metal article according to a first embodiment of the present invention.

FIG. 2 is a graph showing the bending stress test results of a bonded metal article produced by using a nickel paste, a bonded metal article produced by using no metal pastes, and a bonded metal article produced by using a silver paste.

FIG. 3 is a list showing redox potentials of base metals to noble metals.

FIG. 4 is a graph showing the relationship between the bonding strength and the exposed area of the silver paste applied to the bonding surface.

FIG. 5 is a scanning electron microscope (SEM) photograph of a portion in the vicinity of a bonding interface in the bonded metal article of the first embodiment.

FIG. 6 is an in-depth profile of silver measured by an energy dispersive X-ray spectroscopic analysis (EDX) from an upper second thin steel plate to a lower first thin steel plate.

FIG. 7 is a longitudinal cross-sectional side view of a bonded metal article according to a second embodiment of the present invention.

FIG. 8 is an SEM photograph of a portion in the vicinity of a bonding interface in the bonded metal article of the second embodiment.

FIG. 9 is an in-depth profile of silver measured by the EDX from a thin aluminum alloy plate to a thin steel plate.

FIG. 10 is an in-depth profile of oxygen measured by a microspectroscopic analysis when the thin aluminum alloy plate and the thin steel plate are bonded without the silver paste.

FIG. 11 is an in-depth profile of oxygen measured by the microspectroscopic analysis when the thin aluminum alloy plate and the thin steel plate are bonded with the silver paste.

FIG. 12 is a graph showing the hardness measurement results of the thin aluminum alloy plates in the bonded metal article produced by bonding the thin aluminum alloy plate and the thin steel plate without the silver paste, and in the bonded metal article produced by bonding the thin aluminum alloy plate and the thin steel plate with the silver paste.

FIG. 13 is a graph showing the relationship between the bonding strength and the thickness of the bonding interface (the intermetallic compound).

FIG. 14 is a matrix diagram showing combinations of first and second metal workpieces.

FIG. 15 is an overall schematic side view of an engine valve (bonded metal article) produced by bonding a first metal workpiece having an approximately truncated cone shape and a second metal workpiece having an approximately columnar shape.

### DESCRIPTION OF EMBODIMENTS

Several preferred embodiments of the bonded metal article of the present invention will be described in detail below with reference to the accompanying drawings.

In a first embodiment, first and second metal workpieces containing the same metal (steel plate) are used. The first embodiment will be described below.

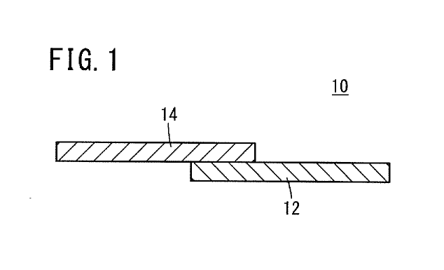

FIG. 1 is a longitudinal cross-sectional side view of a bonded metal article 10 according to the first embodiment. The bonded metal article 10 is obtained by bonding together a first thin steel plate 12 (the first metal workpiece) and a second thin steel plate 14 (the second metal workpiece) in a bonding process such as an ultrasonic bonding process or a friction pressure welding process.

For example, the first thin steel plate 12 and the second thin steel plate 14 contain a chromium-molybdenum steel. Specific examples of the steels include SCM420 equivalent materials according to Japanese Industrial Standards (JIS).

The bonding of the first thin steel plate 12 and the second thin steel plate 14 will be described below. First, a metal paste is prepared by dispersing fine metal particles in a dispersion medium, and is applied to at least one of a bonding surface of the first thin steel plate 12 and a bonding surface of the second thin steel plate 14.

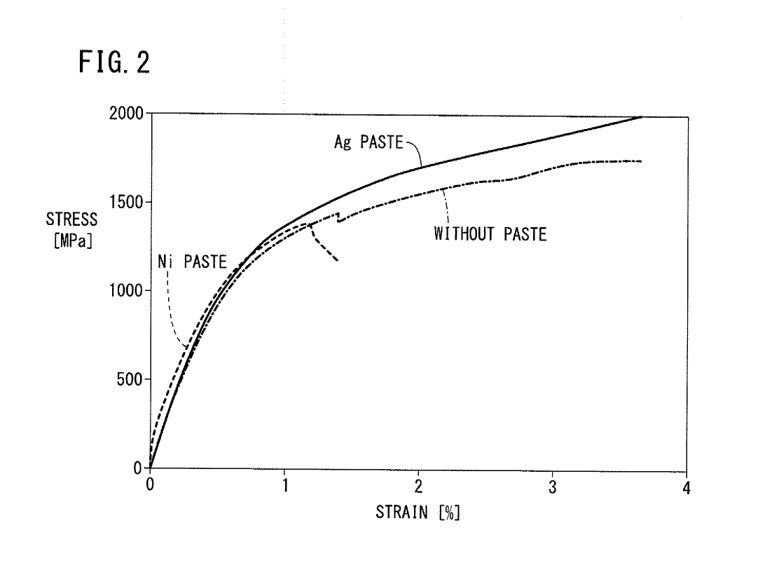

FIG. 2 is a graph showing the bending stress test results of bonded metal articles. The tested articles include a bonded metal article produced by using a nickel paste containing fine particles of nickel (Ni having a more negative redox potential than that of H₂) as the metal paste, applying the nickel paste to the bonding surface, and bonding the first thin steel plate 12 and the second thin steel plate 14 in the friction pressure welding process, a bonded metal article produced by bonding the first thin steel plate 12 and the second thin steel plate 14 in the friction pressure welding process using no metal pastes, and a bonded metal article produced by using a silver paste containing fine particles of silver (Ag having a more positive redox potential than that of H₂), applying the silver paste to the bonding surface, and bonding the first thin steel plate 12 and the second thin steel plate 14 in the friction pressure welding process. The bonded metal articles produced by using the nickel paste or no metal pastes were separated (broken) at the bonding interfaces. The bonded metal article produced by using no metal pastes exhibited a higher breaking stress.

The bonded metal article produced by using the silver paste exhibited a breaking stress higher than that of the bonded metal article produced by using no metal pastes. In the bonded metal article produced by using the silver paste, not the bonding interface but the base material (the first thin steel plate 12) was broken.

A bonded metal article produced by using different metals in the first and second metal workpieces, a bonded metal article produced by using a base metal other than nickel in the fine metal particles for the metal paste, and a bonded metal article produced by using a noble metal other than silver in the fine metal particles for the metal paste exhibited the same tendency.

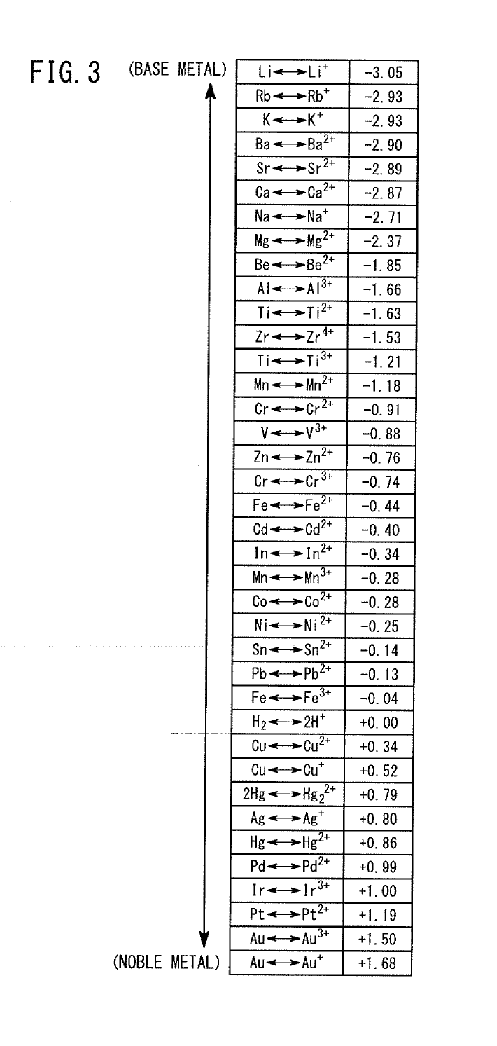

Thus, a metal having a more positive redox potential than that of H₂ is selected as a component of the fine metal particles to achieve a bonding strength higher than that of the bonded metal article produced by using no metal pastes. Specific examples of such metals include Cu (copper), Ag (silver), platinum (Pd), platinum (Pt), and the like, as is clear from FIG. 3 showing redox potentials of base/noble metals. The silver paste containing the fine silver particles is preferred from the viewpoints of cost and bonding strength. The silver paste is used in the following example.

It is preferred that the silver paste contains fine silver particles having an average particle diameter of less than 1 μm (e.g., 1 to 100 nm), i.e., so-called silver nanoparticles. The silver paste may contain silver microparticles having a larger average particle diameter (e.g., 1 to 5 μm). The silver paste containing such microparticles is advantageously capable of reducing the bonding cost because it is available at a lower price as compared with the silver paste containing the nanoparticles. It is to be understood that the silver paste may contain fine silver particles having an average particle diameter of more than 100 nm but less than 1 μm, e.g., 500 nm (0.5 μm).

The silver paste may be prepared by dispersing the above described fine silver particles in the dispersion medium. Preferred examples of the dispersion media include polar solvents such as aromatic alcohols (e.g., benzylalcohol), propylene glycol monomethyl ether acetate (PEGMEA), polyethylene glycol monomethacrylate (PEGMA), and terpineol. A dispersing agent of an unsaturated fatty acid ester may be added to the polar solvent.

The silver paste may be applied to at least one of the bonding surface of the first thin steel plate 12 and the bonding surface of the second thin steel plate 14 by a known application method such as screen printing, pad printing, blade coating, and brush coating.

In a case where the content of the fine silver particles in the silver paste or the amount of the applied silver paste is excessively small, sufficient bonding strength cannot be achieved. Therefore, it is preferred that the exposed area of the silver per unit weight is increased to a certain value or more by controlling the particle diameter, the content, and the application amount of the silver particles.

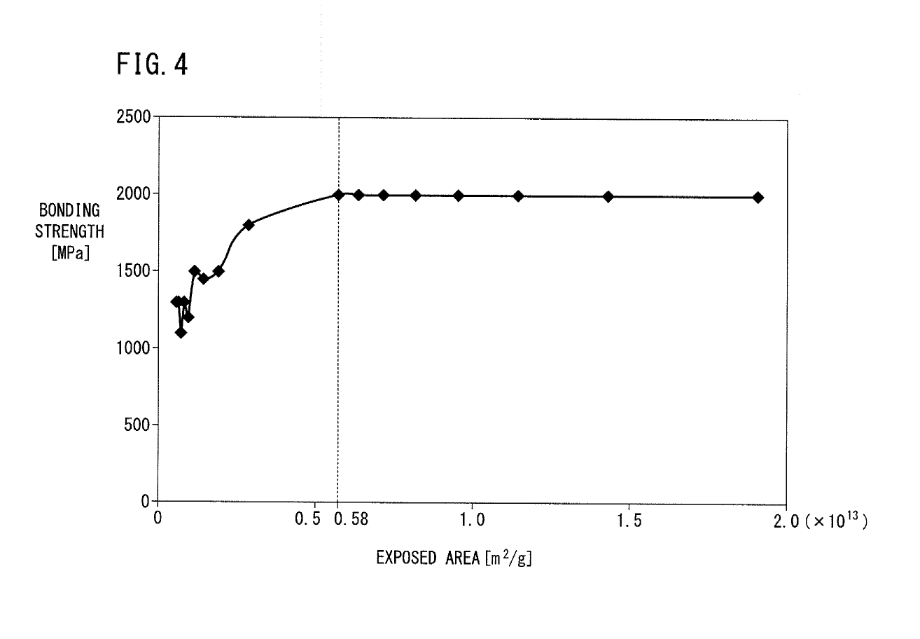

FIG. 4 is a graph showing the relationship between the bonding strength and the exposed area of the silver paste applied to the bonding surface. As is clear from FIG. 4, when the exposed area is 5.8×10¹² m²/g or more, an excellent bonding strength, which is comparable to the strength of the base material (the first thin steel plate 12 or the second thin steel plate 14), can be achieved. Also in a case where the other metal members are used as the first and second metal workpieces, the same tendency is exhibited.

For example, when the silver particles have an average particle diameter 2r, the surface area Sr of the approximate sphere is calculated by the following equation (1):

Sr=4×π×r² (1)

The weight of Ag per unit volume is 10.49×10⁻⁶ g/m². Therefore, the volume V and the weight w of one silver particle are calculated respectively by the following equations (2) and (3):

V=(4/3)×π×r³ (2)

w=V×10.49×10⁻⁶ (3)

The number of the silver particles in the silver paste is obtained from a product of the weight and the silver content of the silver paste. For example, when the content of the silver particles in the silver paste is 77.5% and the application amount of the silver paste is 0.16 μg/mm², the number N of the silver particles is calculated by the following equation (4):

N=(0.16×0.775)/w (4)

Thus, the exposed area A of the silver particles is calculated by the following equation (5):

A=(N×Sr)/Silver paste application amount (5)

As is clear from the equation (5), the exposed area of the fine silver particles can be increased to 5.8×10¹² m²/g or more by controlling the average particle diameter of the fine silver particles to less than 77 nm. It is to be understood that even when the average particle diameter is 77 nm or more, the preferred exposed area can be achieved by increasing the amount of the silver paste applied per unit are of the bonding surface.

In the friction pressure welding process, the first thin steel plate 12 is fixed to a first rotary holder, while the second thin steel plate 14 is fixed to a second rotary holder, and the first and second rotary holders are rotationally actuated. Then, the first thin steel plate 12 and the second thin steel plate 14 may be brought closer to each other into sliding contact with each other.

In the ultrasonic bonding process, the first thin steel plate 12 and the second thin steel plate 14 are stacked to form an overlapping portion in such a manner that the bonding surfaces are arranged facing each other with the silver paste positioned therebetween. For example, the first thin steel plate 12 is fixed in a predetermined position, and an ultrasonic horn is brought into contact with the overlapping portion of the first thin steel plate 12 and the second thin steel plate 14. Then, a vibration generated by an ultrasonic wave from the ultrasonic horn is transmitted through the second thin steel plate 14 to the bonding surfaces and the silver paste while applying a load to the first thin steel plate 12 and the second thin steel plate 14 in such a direction that the bonding surfaces are brought closer to each other.

In the bonding process, the dispersion medium in the silver paste is vaporized, and the fine silver particles are diffused in the first thin steel plate 12 or the second thin steel plate 14. Furthermore, a solid-phase diffusion bonding is caused between the first thin steel plate 12 and the second thin steel plate 14. As a result, a bonding interface is formed between the first thin steel plate 12 and the second thin steel plate 14.

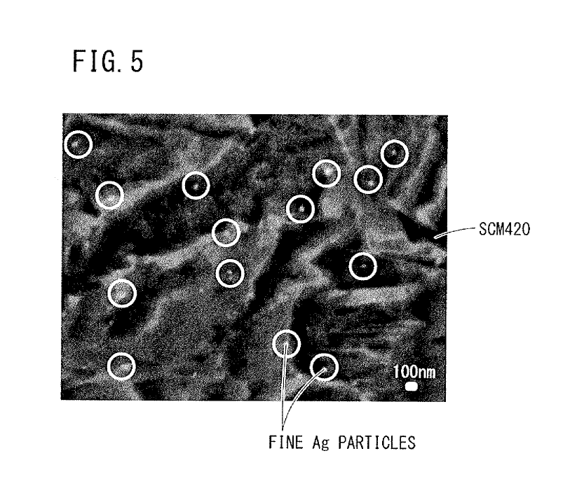

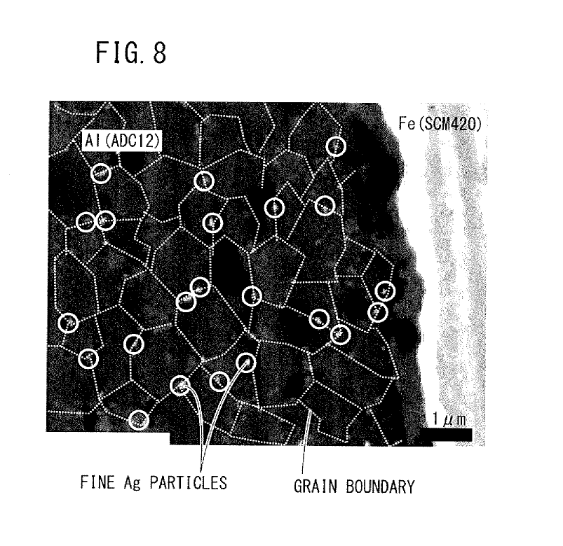

FIG. 5 is a scanning electron microscope (SEM) photograph of a portion in the vicinity of the bonding interface. As shown in FIG. 5, the fine silver particles are diffused in both of the first thin steel plate 12 and the second thin steel plate 14 approximately uniformly, and are dispersed in the grain boundaries in the first thin steel plate 12 and the second thin steel plate 14. The strengths, hardnesses, and the like of the first thin steel plate 12 and the second thin steel plate 14 are improved due to the silver diffusion. Though the fine silver particles are surrounded by circles to facilitate recognition of the particles in FIG. 5, of course the circles are not present in the metal structure. Such circles are shown also in FIG. 8.

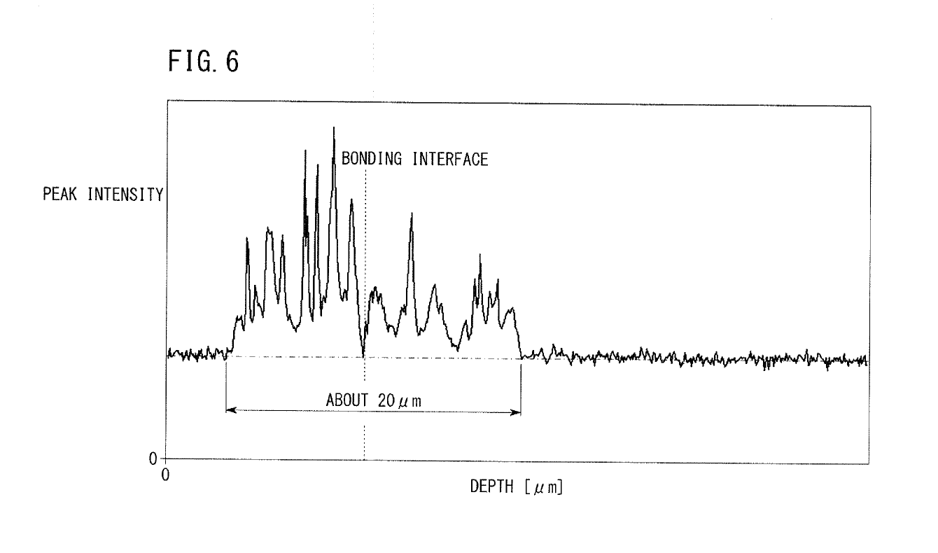

FIG. 6 is an in-depth profile of silver measured by an energy dispersive X-ray spectroscopic analysis (EDX) from the upper second thin steel plate 14 to the lower first thin steel plate 12. The vertical solid line shown in FIG. 6 represents the bonding interface. As shown in FIG. 6, the peak intensity at the bonding interface is approximately equal to the background intensity, and peaks with sufficient intensities are observed around the bonding interface. Therefore, it is clear that the fine silver particles are not present in the bonding interface and are dispersed in the first thin steel plate 12 and the second thin steel plate 14. Based on this result, it is presumed that the fine silver particles in the silver paste are not directly involved in the bonding.

It is also clear from FIG. 6 that the silver peak intensity is reduced as a distance from the bonding interface increases. This means that the density of the diffused fine silver particles is gradually reduced as a distance from the bonding interface increases. Thus, the portion containing the diffused fine silver particles has a gradient composition. The portion containing the diffused silver particles (the portion having the gradient composition) is a region having a length of about 10 μm in the depth direction from the bonding interface in each of the first thin steel plate 12 and the second thin steel plate 14, i.e., having a total length of about 20 μm.

In a case where the first thin steel plate 12 and the second thin steel plate 14 are bonded in the same manner except for using no silver pastes, oxygen is detected at the bonding interface in an elemental analysis using an electron beam microanalyzer (EPMA). In contrast, in a case where the silver paste is used, oxygen is not detected at the bonding interface in the elemental analysis using the EPMA. It is clear from the analysis results that the fine silver particles are diffused in the first thin steel plate 12 and the second thin steel plate 14 while capturing the oxygen, so that the oxygen is not present in the bonding interface.

In a case where the oxygen is captured by the fine silver particles in the above manner, passive films are reduced and removed from the bonding interface, and the active underlying metal materials are exposed at the bonding interface. In addition, the passive films are not formed again on the surfaces of the underlying metal materials because also oxygen in the atmosphere is captured by the fine silver particles. Therefore, a metallic bond can be readily formed between the underlying metal materials.

Consequently, the strong metallic bond is formed between the underlying metal materials, and brittle fracture is prevented due to the absence of the oxygen, whereby the bonding strength is improved in the vicinity of the bonding interface.

In a case where the metal paste contains fine particles of a metal other than silver, having a more positive redox potential than that of H₂, the same behavior is observed. The bonding strength is improved by using the metal paste containing the fine particles of the metal having the more positive redox potential than that of H₂. This is presumed because the metal acts as an oxygen scavenger for capturing the oxygen and therefore the metallic bond is formed between the underlying metal materials.

In the first embodiment, the first metal workpiece and the second metal workpiece contain similar metals, and the bonding interface is defined as a region where the above metallic bond is formed and the oxygen is not present (the peak intensity is approximately equal to the background intensity or negligibly low in an in-depth profile). The thickness of the bonding interface depends on the load for the bonding process, and is increased as the load becomes larger.

When the bonding interface has an excessively large thickness, the internal stress difference between the bonding interface and the first thin steel plate 12 or the second thin steel plate 14 is increased, whereby the bonding strength is lowered. From the viewpoint of preventing the lowering, it is preferred that the bonding interface has a thickness of 0.1 to 1.8 μm. In the ultrasonic bonding process, the applied load may have a magnitude of 30 to 50 MPa, and the ultrasonic wave output from the ultrasonic horn may have an intensity of 900 to 3000 W under a frequency of 2 kHz.

The thickness of the bonding interface is more preferably 0.3 to 1.6 μm, further preferably 0.5 to 1.3 μm, most preferably 1 μm.

Next, a second embodiment will be described below. In the second embodiment, first and second metal workpieces containing different metals are used.

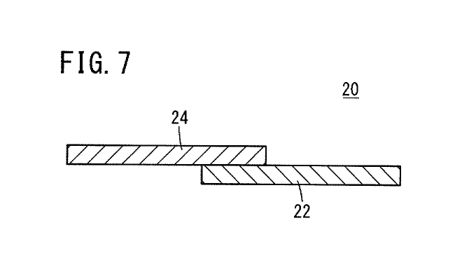

FIG. 7 is a longitudinal cross-sectional side view of a bonded metal article 20 according to the second embodiment. The bonded metal article 20 is obtained by bonding together a thin aluminum alloy plate 22 (the first metal workpiece) and a thin steel plate 24 (the second metal workpiece) in the bonding process such as the ultrasonic bonding process or the friction pressure welding process in the same manner as the first embodiment.

Preferred examples of materials for the thin aluminum alloy plate 22 include ADC12 equivalent materials according to JIS. On the other hand, preferred examples of materials for the thin steel plate 24 include chromium-molybdenum steels such as SCM420 equivalent materials as in the first thin steel plate 12. In this combination, the ADC12 equivalent material has a lower melting point.

The thin aluminum alloy plate 22 and the thin steel plate 24 are bonded by using the metal paste, preferably using the silver paste, in the same manner as the first embodiment. The fine silver particles in the silver paste applied to the bonding surface preferably has an exposed area of 5.8×10¹² m²/g or more in the same manner as the first embodiment.

FIG. 8 is an SEM photograph of a portion in the vicinity of the bonding interface in the bonded metal article 20. The left black region corresponds to the thin aluminum alloy plate 22 (the ADC12 equivalent material), the right white region corresponds to the thin steel plate 24 (the SCM420 equivalent material), the intermediate gray region corresponds to the bonding interface, and the dashed lines represent crystal grain boundaries. It is clear from FIG. 8 that the silver particles are dispersed along the crystal grain boundaries also in the second embodiment.

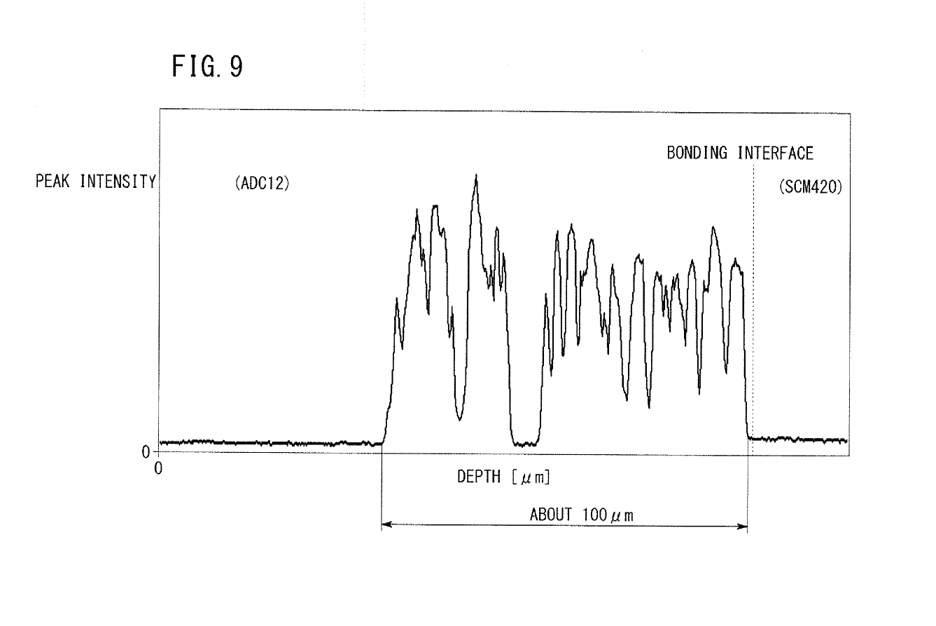

The silver particles are preferentially diffused into the thin aluminum alloy plate 22 having the lower melting point, and are not observed in the crystal grain boundaries of the thin steel plate 24. This is supported also by FIG. 9, which is an in-depth profile of silver measured by the EDX from the thin aluminum alloy plate 22 to the thin steel plate 24. Thus, in FIG. 9, no peaks are observed in the bonding interface represented by the vertical solid line and in the thin steel plate 24. In contrast, peaks with sufficient intensities are observed in the thin aluminum alloy plate 22.

The silver particles are diffused in the crystal grain boundaries in the thin aluminum alloy plate 22 having the lower melting point, whereby the strength, hardness, and the like of the thin aluminum alloy plate 22 are improved. For example, in measurement using a nanoindenter, an ADC12 material has an average hardness of about 1700 MPa, and in contrast the thin aluminum alloy plate 22 in the bonded metal article 20 produced by using the silver paste has a significantly high average hardness of 3200 MPa. It should be noted that the average hardness of the thin aluminum alloy plate 22 in a bonded metal article produced by using no silver pastes is approximately equal to or slightly higher than that of the ADC12 material.

The density of the diffused fine silver particles is gradually reduced as a distance from the bonding interface increases. Thus, the portion containing the diffused fine silver particles has a gradient composition. As is clear from FIG. 9, the portion containing the diffused silver particles (the portion having the gradient composition) is a region having a length of about 100 μm or less in the depth direction from the bonding interface to the thin aluminum alloy plate 22.

It is clear from the above result that the fine silver particles are not present in the bonding interface. Based on this result, it is presumed that the fine silver particles in the silver paste are not directly involved in the bonding also in the second embodiment.

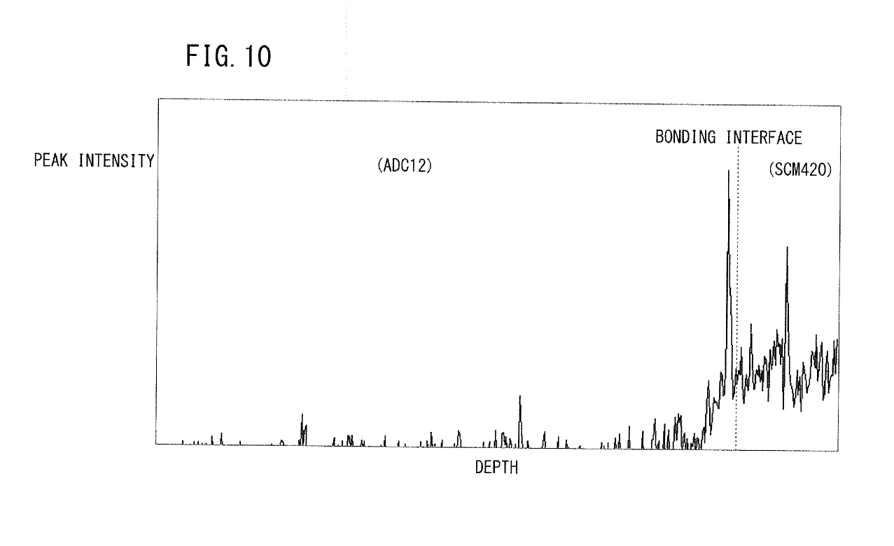

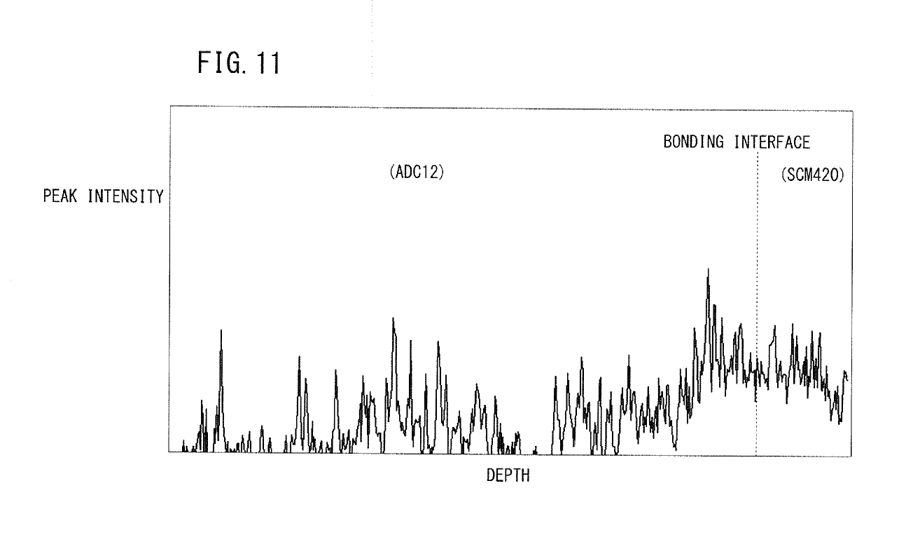

FIG. 10 is an in-depth profile of oxygen of the thin aluminum alloy plate 22 and the thin steel plate 24 bonded without the silver paste measured by a microspectroscopic analysis, and FIG. 11 is an in-depth profile of oxygen of the thin aluminum alloy plate 22 and the thin steel plate 24 bonded with the silver paste measured by the microspectroscopic analysis. As compared with FIG. 10, more oxygen is clearly diffused into the thin aluminum alloy plate 22 in FIG. 11. Furthermore, in an instrumental analysis such as EPMA, the oxygen is not detected at the bonding interface.

It is clear from the results that also in this embodiment, the fine silver particles are diffused in the thin aluminum alloy plate 22 while capturing the oxygen, so that the oxygen is not present in the bonding interface.

Also in the second embodiment, passive films are reduced and removed from the bonding interface, and the active underlying metal materials are exposed at the bonding interface. An intermetallic compound having a metallic bond is generated from the exposed underlying metal materials. The intermetallic compound is a type of metal and has an excellent toughness.

The intermetallic compound contains iron (Fe) from the thin steel plate 24 and aluminum (Al) from the thin aluminum alloy plate 22. The intermetallic compound does not contain oxygen as described above, whereby brittle fracture is hardly caused in the compound.

For the above reasons, the intermetallic compound is generated and leads to an excellent bonding strength.

In general, intermetallic compounds have high hardness. Therefore, in the second embodiment, the bonding interface has a relatively high hardness. Meanwhile, in the thin aluminum alloy plate 22 and the thin steel plate 24, inner portions not containing the diffused fine silver particles have a relatively low hardness. In general, when a high-hardness layer and a low-hardness layer are arranged closer to each other, a residual stress (internal stress) is often generated. However, in the second embodiment, the portion having the gradient composition, wherein the density of the diffused silver particles is gradually changed, is formed between the bonding interface and the inner portion.

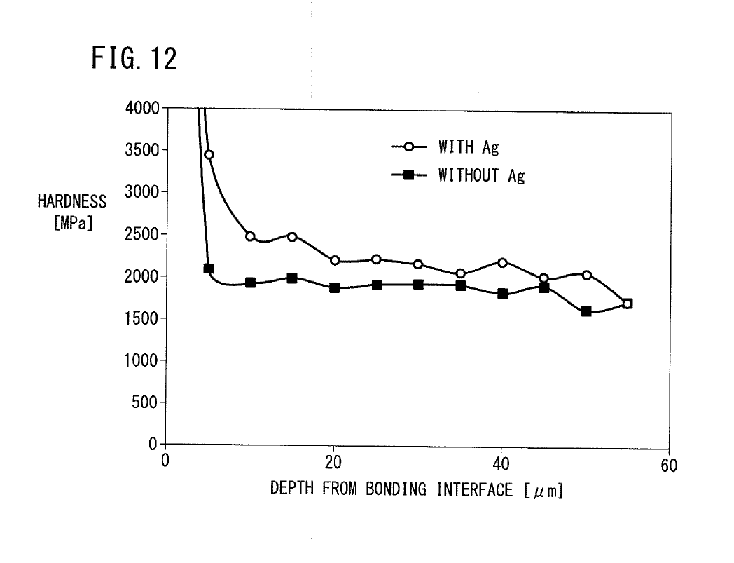

FIG. 12 is a graph showing the hardness measurement results of the thin aluminum alloy plates 22 in the bonded metal article produced by bonding the thin aluminum alloy plate 22 and the thin steel plate 24 without the silver paste and the thin aluminum alloy plates 22 in the bonded metal article 20 produced by bonding the thin aluminum alloy plate 22 and the thin steel plate 24 with the silver paste. The hardnesses are measured using a nanoindenter, and the horizontal axis represents the distance (depth) from the bonding interface.

As is clear from FIG. 12, the hardness is sharply decreased with increasing distance from the bonding interface in the bonded metal article produced by using no silver pastes. In contrast, the hardness is decreased modestly in the bonded metal article 20 produced by using the silver paste. The hardness is gradually changed in the portion having the gradient composition. Therefore, the internal stress is relaxed in the portion having the gradient composition to prevent the separation at the bonding interface.

In general, it is difficult to bond a member composed of an iron-based alloy such as a steel material and a member composed of an aluminum alloy. In the second embodiment, such members can be easily bonded together by a simple process without large-scale bonding equipment and complicated procedure.

In the second embodiment, the bonding interface is defined as a region where the intermetallic compound and thus the metallic bond are formed and the oxygen is not present. The thickness of the bonding interface depends on the load for the bonding process, and is increased as the load becomes larger.

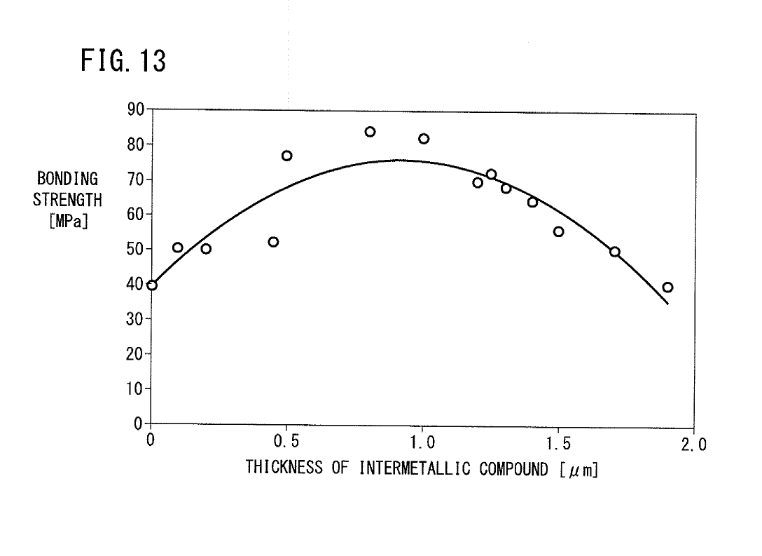

FIG. 13 is a graph showing the relationship between the bonding strength and the thickness of the bonding interface (the intermetallic compound). As is clear from FIG. 13, a satisfactory bonding strength of 50 MPa or more can be achieved by controlling the thickness of the bonding interface within a range of 0.1 to 1.8 μm.

A bonding strength of 60 MPa or more can be obtained by controlling the thickness of the bonding interface within a range of 0.3 to 1.6 μm, and a bonding strength of 70 MPa or more can be obtained by controlling the thickness within a range of 0.5 to 1.3 μm. Furthermore, a bonding strength of about 80 MPa can be obtained by controlling the thickness at 1 μm.

It is clear from the results that the thickness of the bonding interface is preferably 0.1 to 1.8 μm, more preferably 0.3 to 1.6 μm, further preferably 0.5 to 1.3 μm, and most preferably 1 μm.

The present invention is not limited to the first and second embodiments, and various changes and modifications may be made therein without departing from the scope of the invention.

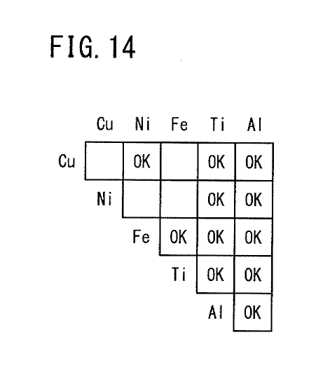

For example, the first and second metal workpieces are not limited to the thin aluminum alloy plate 22 and the thin steel plate 24, and may be selected from various combinations shown in FIG. 14. The term “OK” in FIG. 14 means that the metal workpieces can be bonded to each other. The metal element names in FIG. 14 are of a metal element having the highest composition ratio in the metal workpiece. Thus, for example, “Ti” includes both of a metal workpiece composed of pure titanium and a metal workpiece composed of a titanium alloy containing titanium at the highest composition ratio.

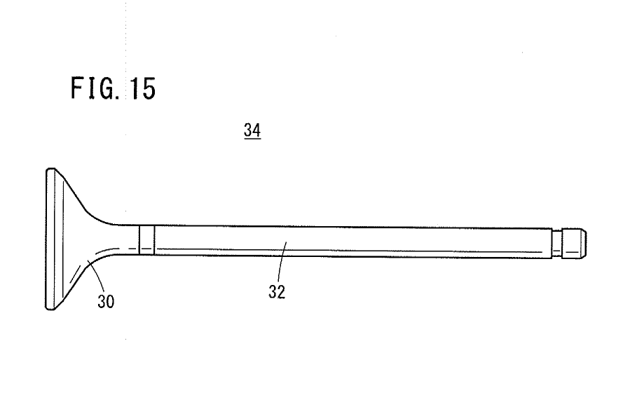

The shapes of the first and second metal workpieces are not limited to the above plate shapes. For example, as shown in FIG. 15, the first metal workpiece may be an umbrella part 30 having an approximately truncated cone shape, and the second metal workpiece may be a shaft part 32 having a long, small-diameter, approximately columnar shape. An engine valve 34 may be produced as the bonded metal article by bonding the umbrella part 30 and the shaft part 32 together.

In this case, the umbrella part may contain a nickel alloy, and the shaft part may contain a heat-resistant martensite steel (such as SUH11).

1. A bonded metal article comprising a first metal workpiece and a second metal workpiece bonded together, wherein
one the first metal workpiece and the second metal workpiece is an iron-based alloy, and another is an aluminum alloy,
fine metal particles of silver are dispersed in crystal grain boundaries in at least one of the first metal workpiece and the second metal workpiece,
a metallic bond is formed between a metal in the first metal workpiece and a metal in the second metal workpiece at a bonding interface between the first metal workpiece and the second metal workpiece, and
in the bonding interface, a peak concerning the metal is not present in an in-depth profile of the fine metal particles measured by an energy dispersive X-ray spectroscopic analysis (EDX), and a peak concerning oxygen is not present in an in-depth profile of oxygen measured by a microspectroscopic analysis.

2. The bonded metal article according to claim 1, wherein the bonded metal article has a gradient composition that an amount of the fine metal particles is larger in a crystal grain boundary closer to the bonding interface and is reduced as a distance from the bonding interface increases.

3. The bonded metal article according to claim 1, wherein the metal contained in the fine metal particles has an oxygen adsorbability.

4. The bonded metal according to claim 1, wherein
the fine metal particles are dispersed in the crystal grain boundaries in the workpiece of the aluminum alloy in the first metal workpiece or the second metal workpiece, and
an intermetallic compound is generated from the metal in the first metal workpiece and the metal in the second metal workpiece due to the metallic bond at the bonding interface between the first metal workpiece and the metal in the second metal workpiece.

5. The bonded metal article according to claim 1, wherein the bonding interface has a thickness of 0.1 to 1.8 μm.

6. The bonded metal article according to claim 5, wherein the bonding interface has a thickness of 0.3 to 1.6 μm.

7. The bonded metal article according to claim 6, wherein the bonding interface has a thickness of 0.5 to 1.3 μm.

8. (canceled)

9. A method for producing a bonded metal article, wherein the bonded metal article contains a first metal workpiece of one of an iron-based alloy and an aluminum alloy and a second metal workpiece of another of the iron-based alloy and the aluminum alloy, bonded together, fine metal particles of silver are dispersed in crystal grain boundaries in at least one of the first metal workpiece and the second metal workpiece, a metallic bond is formed between a metal in the first metal workpiece and a metal in the second metal workpiece at a bonding interface between the first metal workpiece and the second metal workpiece, in the bonding interface, a peak concerning the metal is not present in an in-depth profile of the fine metal particles measured by an energy dispersive X-ray spectroscopic analysis (EDX), a peak concerning oxygen is not present in an in-depth profile of oxygen measured by a microspectroscopic analysis, and the method comprises the steps of:
applying the fine metal particles of silver to at least one of the first metal workpiece and the second metal workpiece,
fixing one of the first metal workpiece and the second metal workpiece to a first rotary holder, fixing another of the first metal workpiece and the second metal workpiece to a second rotary holder, and arranging the first metal workpiece and the second metal workpiece so that a surface to which the fine metal particles are applied faces the first or second metal workpiece, and
rotationally actuating the first rotary holder and the second rotary holder, and bringing the first metal workpiece and the second metal workpiece closer to each other into sliding contact with each other.

10. (canceled)

11. The method according to claim 9, wherein
the silver particles are applied in a form of a silver paste, and
the silver paste is prepared by dispersing the silver particles in a dispersion medium so that an exposed area of the silver particles is 5.8×10¹² m²/g or more.

12. A method for producing a bonded metal article (10), wherein the bonded metal article contains a first metal workpiece of one of an iron-based alloy and an aluminum alloy and a second metal workpiece of another of the iron-based alloy and the aluminum alloy, bonded together, fine metal particles of silver are dispersed in crystal grain boundaries in at least one of the first metal workpiece and the second metal workpiece, a metallic bond is formed between a metal in the first metal workpiece and a metal in the second metal workpiece at a bonding interface between the first metal workpiece and the second metal workpiece, in the bonding interface, a peak concerning the metal is not present in an in-depth profile of the fine metal particles measured by an enemy dispersive X-ray spectroscopic analysis (EDX), a peak concerning oxygen is not present in an in-depth profile of oxygen measured by a microspectroscopic analysis, and the method comprises the steps of:
applying the fine metal particles of silver to at least one of the first metal workpiece and the second metal workpiece,
stacking the first metal workpiece and the second metal workpiece so that a surface to which the fine metal particles are applied faces the first or second metal workpiece to form an overlapping portion, and
bringing an ultrasonic horn into contact with the overlapping portion, and thereafter, transmitting a vibration by an ultrasonic wave output from the ultrasonic horn to the fine metal particles and contact surfaces of the first metal workpiece and the second metal workpiece while applying a load in a direction that the contact surfaces are brought closer to each other.

13. The method according to claim 12, wherein
the load applied to the contact surfaces has a magnitude of 30 to 50 MPa, and
the ultrasonic wave output from the ultrasonic horn has an intensity of 900 to 3000 W.

14. (canceled)

15. The method according to claim 12, wherein
the silver particles are applied in a form of a silver paste, and
the silver paste is prepared by dispersing the silver particles in a dispersion medium so that an exposed area of the silver particles is 5.8×10¹² m²/g or more.
